(19) United States
(12) Patent Application Publication
(10) Pub. No.: US 2012/0285673 A1
(43) Pub. Date: Nov. 15, 2012

(54) NANOSTRUCTURED COMPOSITE POLYMER THERMAL/ELECTRICAL INTERFACE MATERIAL AND METHOD FOR MAKING THE SAME

(75) Inventors: Baratunde A. COLA, Atlanta, GA (US); Kyriaki Kalaitzidou, Atlanta, GA (US); Handoko T. Santoso, Surabaya (ID); Virendra Singh, Atlanta, GA (US)

(73) Assignee: Georgia Tech Research Corporation, Atlanta, GA (US)

(21) Appl. No.: 13/469,894

(22) Filed: May 11, 2012

Related U.S. Application Data
(60) Provisional application No. 61/484,937, filed on May 11, 2011.

(51) Int. Cl. F28F 7/00; B32B 5/16; B82Y 30/00

(52) U.S. Cl. 165/185; 428/119; 977/762; 977/734

(57) ABSTRACT

An exemplary embodiment of the present invention provides a thermal interface material for providing thermal communication between a heat sink and a heat source. The thermal interface material comprises a plurality of polymer nanofibers having first ends and second ends. The first ends can be positioned substantially adjacent to the heat source. The second ends can be positioned substantially adjacent to the heat sink. The plurality of polymer nanofibers can be aligned substantially perpendicular to at least a portion of the heat source and the heat sink.

### CROSS-REFERENCE TO RELATED APPLICATIONS

This application claims the benefit of U.S. Provisional Application Ser. No. 61/484,937, filed on 11 May 2011, which is incorporated herein by reference in its entirety as if fully set forth below.

### TECHNICAL FIELD OF THE INVENTION

The various embodiments of the present disclosure relate generally to thermal transfer systems. More particularly, the various embodiments of the present invention are directed to nanostructured polymer based thermal interface materials.

### BACKGROUND OF THE INVENTION

Thermal interface materials (“TIMs”) are used in many systems where it is desirable to transfer heat from a heat source to a heat sink. For example, in a three-dimensional stack of microchips, it is often desirable to transfer heat generated by a chip to a heat sink in order to cool the chip. Heat can be transferred via a TIM located between the heat source and the heat sink. Thus, thermal energy located in the heat source travels through the TIM and to the heat sink.

According to the 2009 International Technology Roadmap for Semiconductors (“ITRS”), TIMS are the major bottleneck in reducing the thermal resistance of packaged electronics. With the power density of chips projected to exceed 100 W/cm² in the near future, the use of some of the best conventional TIMs would still result in a loss of more than 10-20° C. across each interface in a packaged device, severely limiting the temperature available to drive heat rejection from convective surfaces. The 2009 ITRS specifically highlights the need for TIMs that provide high thermal conductivity, are mechanically stable during chip operation, have good adhesion, and conform to fill gaps between two rough surfaces. Conventional TIMs have failed to address such desires.

The performance of state-of-the-art conventional, commercial TIMs rages from 8-30 mm²K/W. Advanced research on carbon nanotube (“CNT”) array TIMs, which have received much attention in recent years, has produced resistances that range from 4-20 mm²K/W. While CNTs appear attractive at first due to their high thermal conductivity, the poor contact between CNTs and substrate presents a major bottleneck to thermal transport. In fact, the contact area established between free CNT ends and an opposing substrate at a relatively large interface pressure of 1 MPa is estimated to be only 1% of the total surface area of the substrate.

Other conventional systems have experimented with employing a variety of polymer and polymer composite TIMs. These systems, however, suffer from choosing between adhesion and mechanical compliance. For example, while polymer-based TIMs have shown significant advancements over prior TIMs, conventional polymer-based TIMs are still limited by the low thermal conductivity of bulk polymers. This drawback has been minimized by the addition of fillers with high thermal conductivity such as metallic nanoparticles and CNTs. Such approaches, however, compromises other properties such as mechanical compliance. Furthermore, the obtained thermal conductivity is lower than the theoretically predicted thermal conductivity because of unfavorable phonon dynamics caused by increased material interfaces and large mismatches in properties of the filler material and polymer matrix.

Therefore, there is a desire for improved TIMs that provide increased thermal conductivity, mechanically stability, adhesion, and contact between a heat source and a heat sink. Various embodiments of the present invention address these desires.

### BRIEF SUMMARY OF THE INVENTION

The present invention relates to thermal interface materials. An exemplary embodiment of the present invention provides a thermal interface material for providing thermal communication between a heat sink and a heat source. The thermal interface material comprises a plurality of polymer nanofibers having first ends and second ends. The first ends can be positioned substantially adjacent to the heat source, and the second ends can be positioned substantially adjacent to the heat sink. The plurality of polymer nanofibers can be aligned substantially perpendicular to at least a portion of the heat source and the heat sink, i.e. aligned in the direction of heat flow.

In an exemplary embodiment of the present invention, at least a portion of the polymer nanofibers comprise conjugated polymer chains. In another exemplary embodiment of the present invention, at least a portion of the polymer nanofibers comprise pi-conjugated polymer chains. In still another exemplary embodiment of the present invention, at least a portion of the plurality of polymer nanofibers are electrically conductive. In some embodiments of the present invention, the electrical conductivity of the at least a portion of the plurality of polymer nanofibers corresponds to a predetermined level of ionic doping. In some embodiments of the present invention, a thermal conductivity of at least a portion of the plurality of polymer nanofibers corresponds to a predetermined level of ionic doping. In still yet another exemplary embodiment of the present invention, at least a portion of the polymer nanofibers comprise a semiconductor material. In some embodiments of the present invention, at least a portion of the polymer nanofibers are electrically insulative.

In an exemplary embodiment of the present invention, at least a portion of the plurality of polymer nanofibers comprise a solution-processable polymer. In another exemplary embodiment of the present invention, the polymer nanofibers have a length and a diameter, wherein the length is greater than the diameter. In still another exemplary embodiment of the present invention, the plurality of polymer nanofibers comprise polythiophene. In yet another exemplary embodiment of the present invention, at least a portion of the plurality of polymer nanofibers are polymer nanotubes. In some embodiments of the present invention, at least a portion of the plurality of polymer nanofibers are polymer nanowires. In some embodiments of the present invention, the thermal interface material has a thermal resistance less than 10 mm²K/W.

In some embodiments of the present invention, the thermal interface material comprises a plurality of fillers having conductivity greater than the conductivity of the polymer nanofibers. In an exemplary embodiment of the present invention, at least a portion of the fillers are carbon nanotubes aligned substantially perpendicular to at least a portion of the heat sink and heat source, i.e. aligned in the direction of heat flow. In another exemplary embodiment of the present invention, at least a portion of the fillers comprise graphene flakes. In still another exemplary embodiment of the present invention, at least a portion of the graphene flakes are aligned substantially perpendicular to at least a portion of the heat sink and heat source.

Another exemplary embodiment of the present invention provides a heat transfer system comprising a heat source, a heat sink, and a thermal interface material. At least a portion of the thermal interface material can be positioned substantially between the heat source and the heat sink to provide thermal communication between the heat source and heat sink. The thermal interface material can comprise a plurality of polymer nanofibers vertically aligned between at least a portion of the heat sink and at least a portion of the heat source.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. While one or more embodiments may be discussed as having certain advantageous features, one or more of such features may also be used with the various embodiments of the invention discussed herein. In similar fashion, while exemplary embodiments may be discussed below as system or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIG. 1A provides a heat transfer system, in accordance with an exemplary embodiment of the present invention.

FIG. 1B provides top and side view images of the thermal interface material shown in FIG. 1A, in accordance with an exemplary embodiment of the present invention.

FIGS. 2A-2B illustrate carbon-carbon bonds in polymers, in accordance with exemplary embodiments of the present invention.

FIGS. 3A-3B illustrate bulk, amorphous polymers and aligned polymers, in accordance with exemplary embodiments of the present invention.

FIGS. 4A-4B provide images illustrating the surface contact area of a CNT array and a polythiophene nanofiber array, respectively, in accordance with an exemplary embodiment of the present invention.

FIG. 5 illustrates a method of fabricating a thermal interface material, in accordance with an exemplary embodiment of the present invention.

FIGS. 6A and 6C provide top view images of an array of vertically aligned polymer nanofibers, in accordance with exemplary embodiments of the present invention.

FIG. 6B provides a side view image of an array of vertically aligned polymer nanofibers, in accordance with an exemplary embodiment of the present invention.

FIG. 7 illustrates results of varying potential during the polymer nanofiber fabrication process, in accordance with exemplary embodiments of the present invention.

FIG. 8A provides a schematic of aligned polymer chains doped with a bulky anion, in accordance with an exemplary embodiment of the present invention.

FIG. 8B provides an schematic of aligned polymer chains doped with surfactant-CNT anionic complex, in accordance with an exemplary embodiment of the present invention.

FIG. 9A illustrates a thermal transfer system with a conventional bulk polymer thermal interface material.

FIG. 9B illustrates a thermal transfer system with aligned polymer nanofibers, in accordance with an exemplary embodiment of the present invention.

FIGS. 10A-10B provide illustrations of the surface contact area of a CNT array and an aligned polymer nanofiber array, respectively, in accordance with an exemplary embodiment of the present invention.

FIG. 11 illustrates a method of fabricating a thermal interface material, in accordance with an exemplary embodiment of the present invention.

### DETAILED DESCRIPTION OF THE INVENTION

To facilitate an understanding of the principles and features of the present invention, various illustrative embodiments are explained below. In particular, the invention is described in the context of being thermal interface materials, heat transfer systems, and methods of fabricating thermal interface materials. Embodiments of the present invention may be applied to many systems or devices where it is desired to transfer thermal energy from a heat source to a heat sink, including, but not limited to, electronic chip stacks.

The components described hereinafter as making up various elements of the invention are intended to be illustrative and not restrictive. Many suitable components or steps that would perform the same or similar functions as the components or steps described herein are intended to be embraced within the scope of the invention. Such other components or steps not described herein can include, but are not limited to, for example, similar components or steps that are developed after development of the invention.

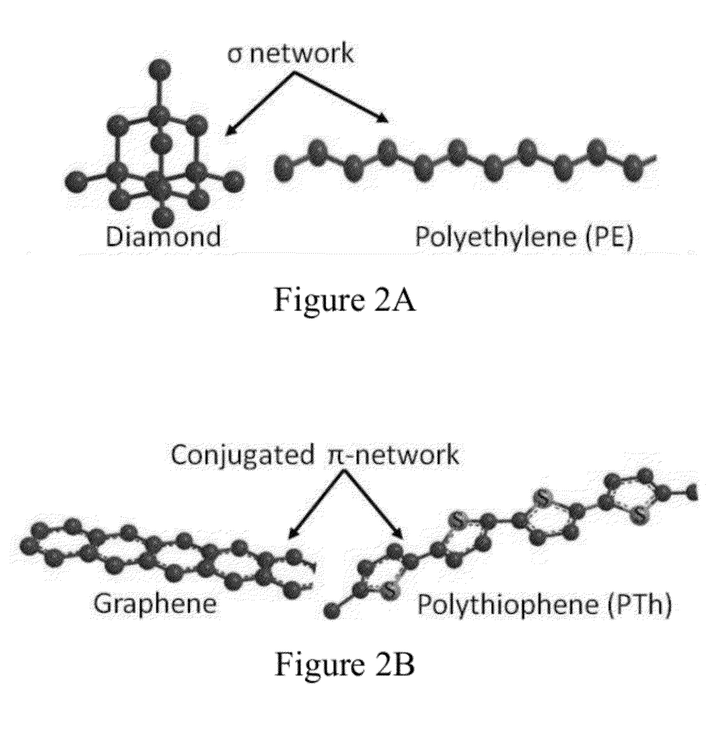

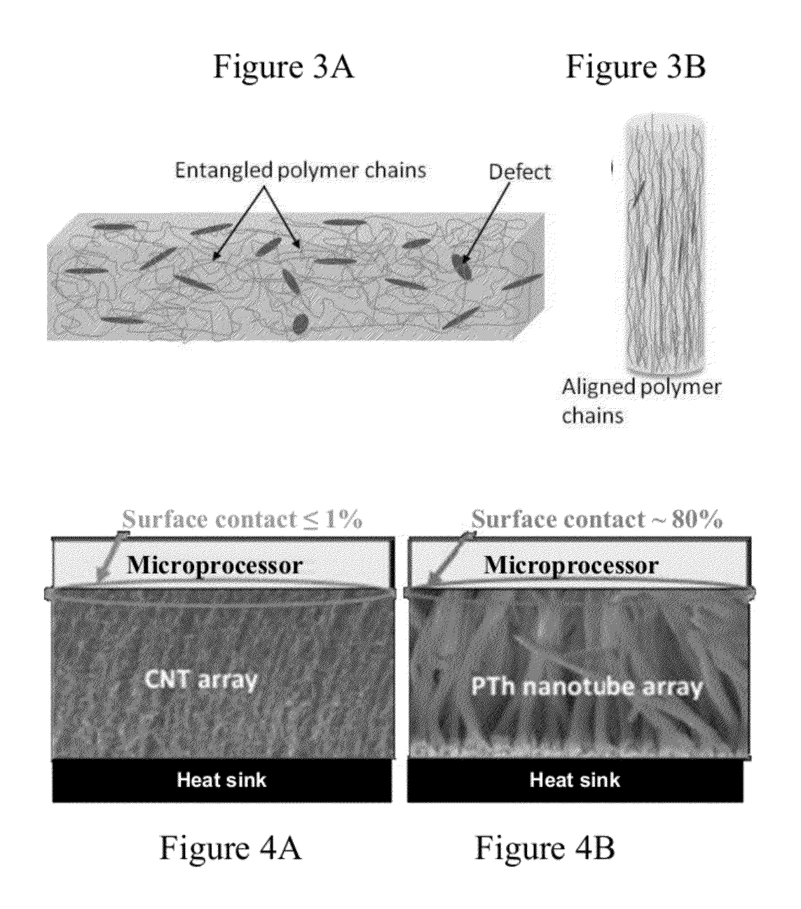

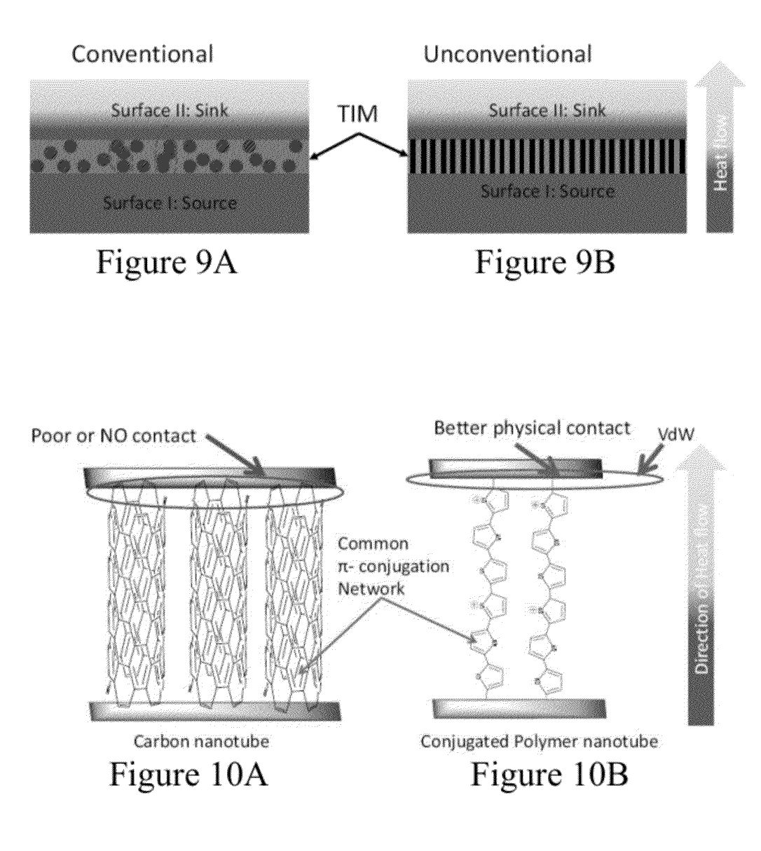

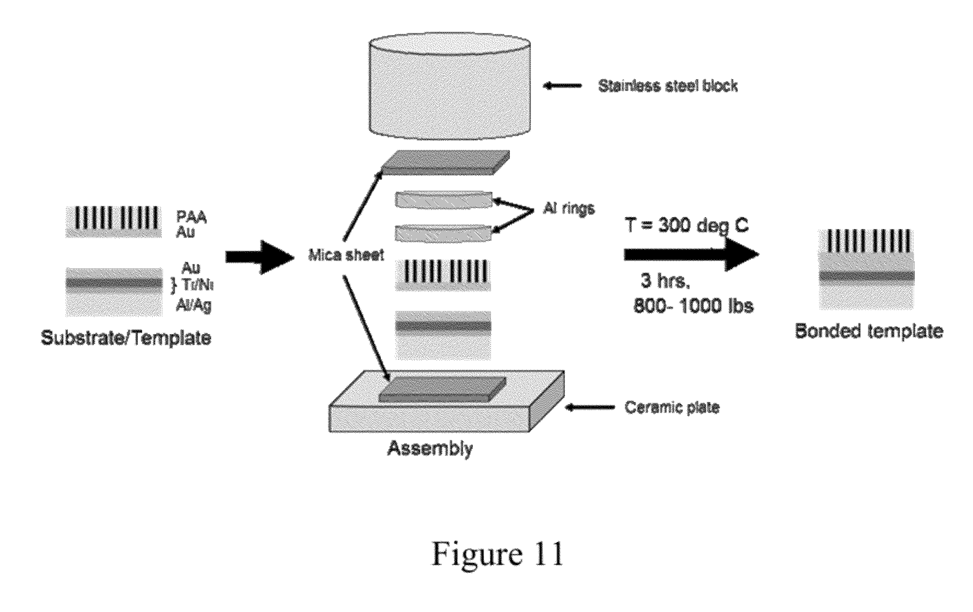

Similar to diamond and graphitic structures such as CNTs and graphene, strong carbon-carbon bonds, as illustrated in FIGS. 2A-2B, provide a strong foundation for high thermal conductivity in polymer chains. As discussed above, however, conventional thermal interface materials have been unable to efficiently utilize these high thermal conductivities in bulk, amorphous polymers because inter-chain phonon scattering virtually eliminates the effects of high thermal conductivity along individual polymer chains. On the other hand, thermal conductivity of polymers can be increased greatly (by orders of magnitude) by stretching polymers to align constituent chains in the direction of heat flow. Additionally, fabrication of polymer fibers with nanoscale dimensions reduces the number of defects and voids in the polymer structures, which allows dense packing of aligned polymer chains. FIG. 3 illustrates a bulk polymer with entangled chains, and FIG. 3B illustrates a polymer with aligned chains. FIG. 9A illustrates the conventional use of bulk polymers in as a thermal interface material. On the other hand, as shown in FIG. 9B, various embodiments of the present invention make use aligned polymer nanofibers in thermal interface materials.

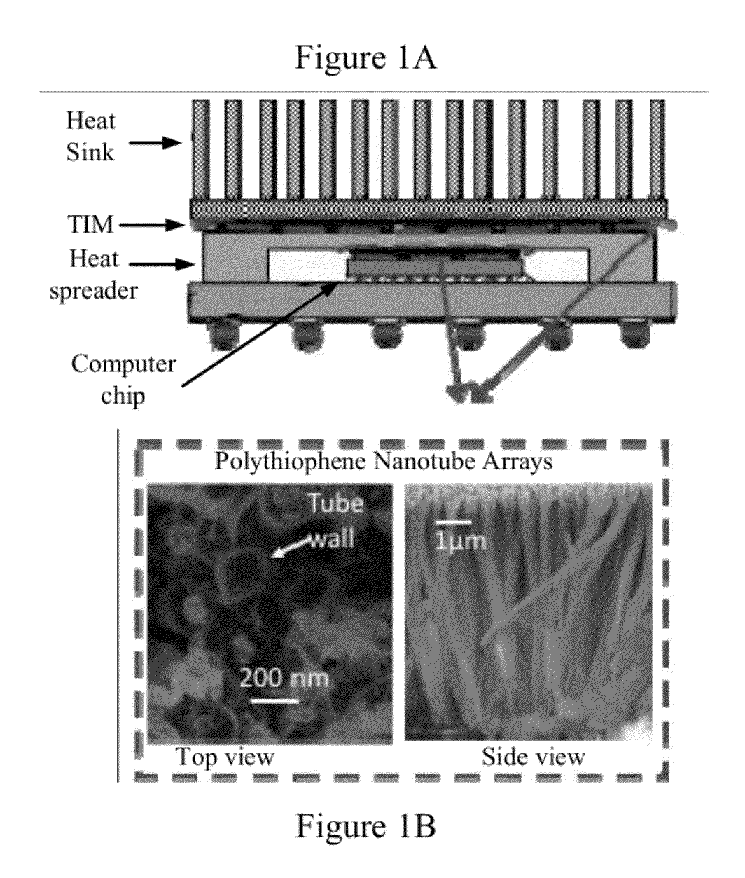

As shown in FIGS. 1A-1B, an exemplary embodiment of the present invention provides a heat transfer system comprising a heat source, a thermal interface material, and a heat sink. The heat source can be many devices or systems known in the art for which it is desirable to transfer thermal energy from. In an exemplary embodiment of the present invention, the heat source is an electronic chip. The heat sink can be many devices or systems known in the art for which it is desirable to transfer thermal energy to. In an exemplary embodiment of the present invention, the heat sink is a second electronic chip. In another exemplary embodiment of the present invention, the heat sink comprises one or more fins in communication with the ambient. At least a portion of the thermal interface material is positioned substantially between the heat source and the heat sink and provides thermal communication between the heat source and the heat sink.

In an exemplary embodiment of the present invention, the thermal interface material comprises a plurality of polymer nanofibers. At least a portion of the polymer nanofibers comprise first ends and second ends. The first ends can be positioned substantially adjacent to the heat source. The second ends can be positioned substantially adjacent to the heat sink. Therefore, in an exemplary embodiment of the present invention, at least a portion of the plurality of polymer nanofibers can be vertically aligned between at least a portion of the heat sink and at least a portion of the heat source, i.e. at least a portion of the plurality of polymer nanofibers are oriented substantially perpendicular to at least a portion of the heat source and a portion of the heat sink. In some embodiments of the present invention, the plurality of polymer nanofibers are grown on any of a variety of substrates. In some embodiments of the present invention, the plurality of polymer nanofibers are part of a free standing film using a thin substrate of the same polymer.

The polymer nanofibers can comprise many polymers known in the art, including naturally occurring and synthetic polymers. In an exemplary embodiment of the present invention, at least a portion of the polymer nanofibers comprise conjugated polymer chains. In another exemplary embodiment of the present invention, at least a portion of the polymer nanofibers comprise pi-conjugated polymer chains. In yet another exemplary embodiment of the present invention, at least a portion of the plurality of polymer nanofibers comprise a solution-processable polymer. As used herein, a solution-processable polymer is any polymer that is soluble. The scope of the present invention is not limited to any specific solution-processable polymer; instead, as those skilled in the art would understand, the scope of the present invention includes many solution-processable polymers, including polythiophene, polypyrrole, poly(3-hexylthiophene), poly(3,4-ethylenedioxythiophene), polyaniline, polystyrene, polyethylene, and the like. Additionally, the scope of the present invention is not limited to solution-processable polymers presently in existence; instead, as those skilled in the art would understand, the scope of the present invention includes solution-processable polymers created in the future.

The plurality of polymer nanofibers can be many different shapes. In an exemplary embodiment of the present invention, at least a portion of the plurality of polymer nanofibers are polymer nanotubes. In another exemplary embodiment of the present invention, at least a portion of the plurality of polymer fibers are polymer nanowires. The polymer nanofibers can have a length and a diameter. In some embodiments of the present invention, the length of polymer nanofibers is greater than the diameter of the polymer nanofibers, i.e. the aspect ratio of the nanofibers is greater than one.

As discussed above, the thermal interface material can provide thermal communication between the heat source and the heat sink. Therefore, at least a portion of the plurality of polymer nanofibers can be thermally conductive. In an exemplary embodiment of the present invention, the thermal conductivity of at least a portion of the plurality of polymer nanofibers corresponds to a predetermined level of ionic doping. Thus, in some embodiments of the present invention, by altering the ionic doping concentration of at least a portion of the plurality of polymer nanofibers, the thermal conductivity/resistance of the thermal interface material can be altered. In an exemplary embodiment of the present invention, the thermal resistance of the thermal interface material is less than 10 mm²K/W.

In addition to providing thermal communication between the heat source and the heat sink, in some embodiments of the present invention, the thermal interface material can provide electrical communication between the heat source and the heat sink. Thus, in an exemplary embodiment of the present invention, at least a portion of the plurality of polymer nanofibers are electrically conductive. In an exemplary embodiment of the present invention, the electrical conductivity of at least a portion of the plurality of polymer nanofibers corresponds to a predetermined level of ionic doping. Thus, in some embodiments of the present invention, by altering the ionic doping concentration of at least a portion of the plurality of polymer nanofibers, the electrical conductivity/resistance of the thermal interface material can be altered.

In yet another exemplary embodiment of the present invention, the thermal interface material electrically isolates the heat source and heat sink, i.e. prevents or minimizes electrical communication between the heat source and the heat sink. Thus, in an exemplary embodiment of the present invention, at least a portion of the plurality of polymer nanofibers are electrically insulative, i.e. have a high electrical resistance.

In another exemplary embodiment of the present invention, at least a portion of the polymer nanofibers can comprise a semiconductor material. The semiconductor material can be many semiconductor materials known in the art, including, but not limited to, silicon, germanium, gallium, polythiophene, poly(3-hexylthiophene), and the like.

In another exemplary embodiment of the present invention, at least a portion of the polymer nanofibers can comprise a thermoelectric material. The thermoelectric material can be many thermoelectric materials known in the art, including, but not limited to, silicon, bismuth telluride, skutterudite, lead telluride, polythiophene, poly(3-hexylthiophene), and the like.

In some embodiments of the present invention, the thermal interface material can comprise a plurality of fillers. In an exemplary embodiment of the present invention, the fillers can have a thermal conductivity greater than the conductivity of the polymer nanofibers. Accordingly, in some embodiments of the present invention, fillers can be used to increase the thermal conductivity of the thermal interface material. In another exemplary embodiment of the present invention, at least a portion of the fillers comprise carbon nanotubes. In some embodiments of the present invention, at least a portion of the carbon nanotubes can be aligned substantially perpendicular to at least a portion of heat sink and heat source, i.e. aligned in the direction of heat flow. In still another exemplary embodiment of the present invention, at least a portion of the fillers comprise graphene flakes. In some embodiments of the present invention, at least a portion of the graphene flakes are aligned substantially perpendicular to at least a portion of the heat sink and heat source.

Various embodiments of the present invention provide a thermal interface material having an increased contact area with the heat source and heat sink. In some embodiments of the present invention, the contact area exceeds 50%. In an exemplary embodiment of the present invention, the thermal interface material has surface contact area of approximately 80%. As shown in FIGS. 4A-4B, this represents an 80 fold increase over conventional thermal interface materials consisting of CNT arrays (FIG. 4A). FIGS. 10A-10B illustrate contact area for a conventional CNT array (FIG. 10A) and aligned polymer nanofibers of the present invention (FIG. 10B). By such drastic increases in contact area, some embodiments of the present invention allow for thermal interface resistances on the order of 1 mm²K/W. In an exemplary embodiment of the present invention, the thermal resistance at the dry contact between polymer nanofiber ends and a mica surface measures approximately 0.9 mm²K/W.

In addition to heat transfers systems and thermal interface materials, the present invention provides methods of fabricating a thermal interface material. An exemplary method of fabricating a thermal interface material comprises a template metallization step, a template bonding step, a nanofiber fabrication step, and a nanofiber isolation step. For example, to form a conductive electrode surface, gold can be deposited on one side of a nanoporous anodic aluminum oxide (“AAO”) template. To grow nanostructures directly on metal foils (or a heat sink surface), the gold coated templates can be bonded to the heat sink surface through metal diffusion bonding. Bonding components and conditions, in accordance with an exemplary embodiment of the present invention, are shown in FIG. 12. Polymer nanofibers can then be fabricated directly on the metal foils by electrochemical oxidation in a three electrodes one compartment cell using an Epsilon electrochemical system and a computer controlled potentiostat-galvanostat. The anodic potential can be measured versus an Ag/AgCl reference electrode. AAO bonded to metal foil can be used as a working electrode, and the area of the working electrode can be defined by kapton mask. A stainless steel foil can be used as counter electrode and mechanically polished before use. The solutions can be de-oxygenated with argon, and a slight overpressure of argon can be maintained during nanostructure growth. The nanostructures can be grown within the nanoporous template at substantially constant potential. To dissolve the AAO template and liberate the vertically aligned array of polymer nanofibers, the template can be treated with potassium hydroxide for a period of time, e.g. 24-48 hours. Isolated arrays of nanofibers can be neutralized with acid and water before attaching them to the substrate.

In accordance with some exemplary embodiments of the present invention, a thermal interface material can be fabricated using either an electrochemical deposition process or by a capillary driven deposition process. A nanoporous template (e.g. porous anodic alumina) can be placed on a conducting substrate that serves as the working electrode in a three electrode electrochemical setup. A monomer of electrically conductive polymer (e.g. polythiophene or another solution-processable polymer) and conductive nanoparticles can be mixed in solution with or without a surfactant. A voltage can then be applied between the working and counter electrodes and the potential field causes the co-deposition of the monomer and conductive nanoparticles in the nanoporous template to form a conductive polymer doped with conductive nanoparticles in each channel in the nanoporous template. High aspect ratio nanoparticles such as CNTs that enter the nanoporous template are forced to align along the channel length due to geometrical constraints. Nanoparticles can also be deposited or grown in the template before deposition of the conductive polymer. The polymer nanofibers can also be deposited with surfactants such as SDS or SDBS to enhance order in the polymer chains and electrical and thermal conductivity. The polymer nanofibers can be wires or tubes, and the tube wall thickness can be varied by controlling synthesis conditions. Thinner tube walls (e.g. <100 nm) can lead to more ordering of polymer chains, which can lead to higher electrical and thermal conductivity. When the polymer nanofibers are grown as vertically oriented arrays of tubes, i.e. oriented in the direction of heat flow, contact area at the heat sink and heat source interfaces can increase. The nanosize of the fibers can lead to increased van der Waals forces between the tubes and contacting substrates, leading to increased adhesive forces and many paths for electrical and heat flow. Polymer nanofiber arrays less than 10 microns tall can produce thermal interface resistances below 10 mm²K/W.

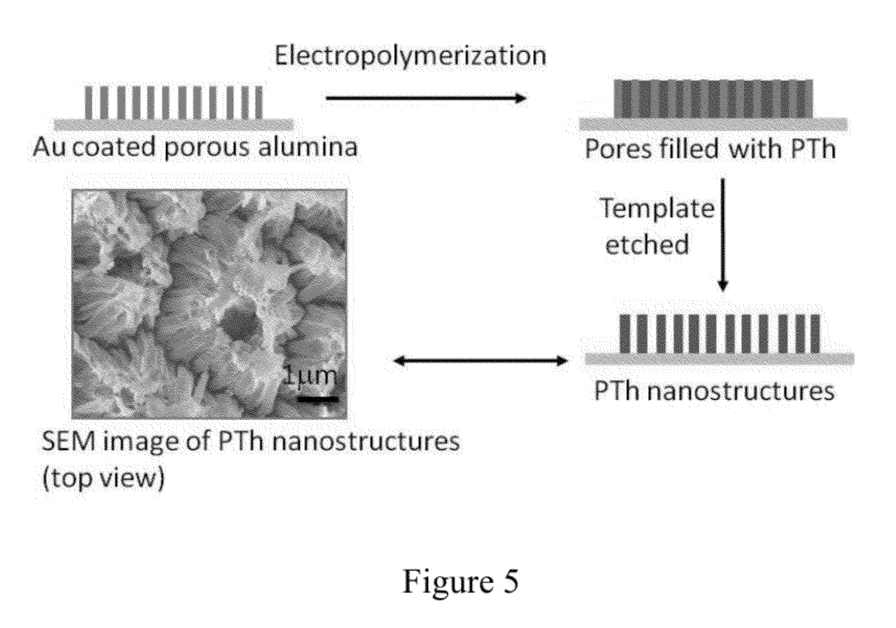

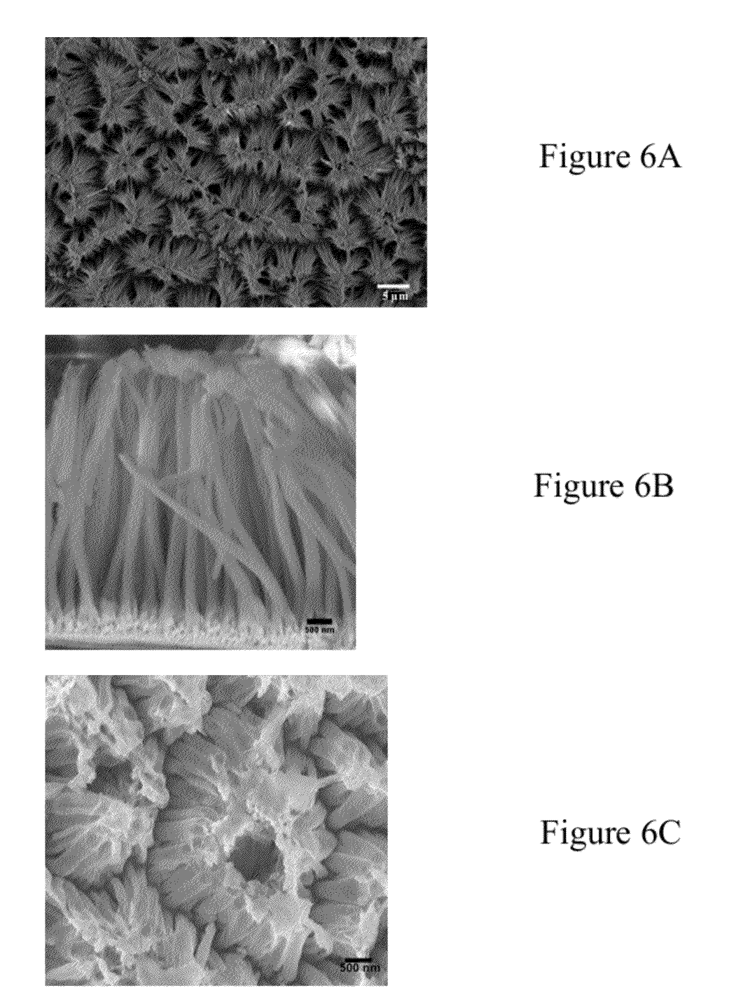

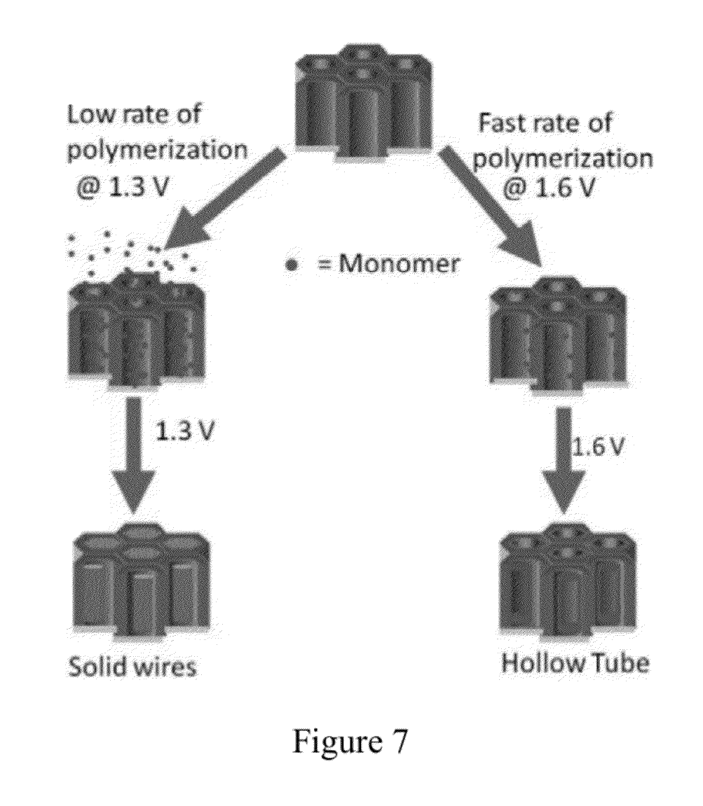

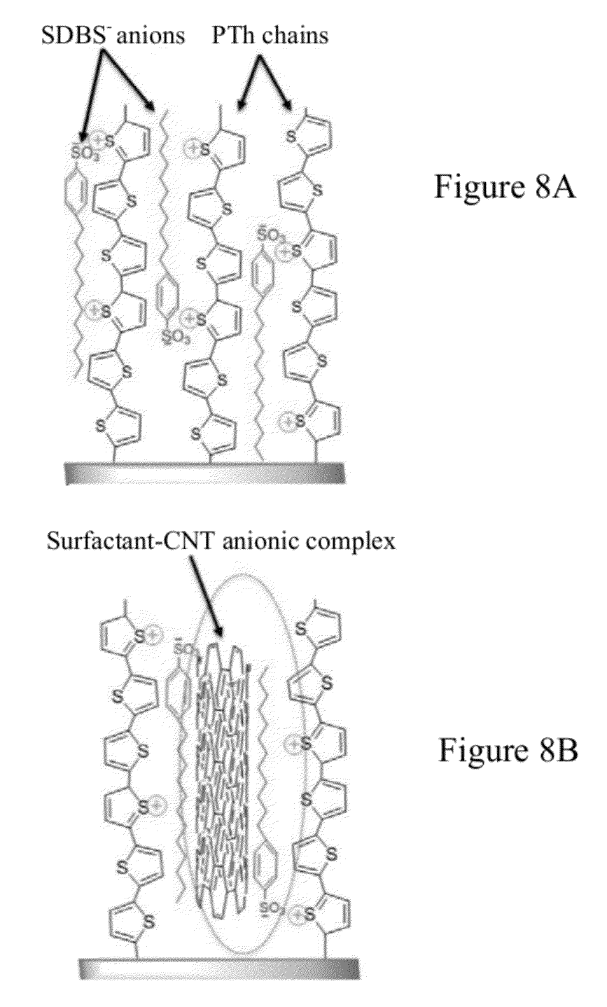

A process of synthesizing polymer nanofibers using a thiophene monomer in accordance with an exemplary embodiment of the present invention as illustrated in FIG. 5 will now be described. Polythiophene tubes can be synthesized at room temperature (˜23° C.) in three electrodes one compartment cell. The anodic potential can be measured versus Ag/AgCl reference electrode. The working and counter electrode used can be substantially the same size metal films and mechanically polished before use. The monomer thiophene for different molar concentrations can be mixed with re-distilled boron flouride-ethyl ether (“BFEE”). Prior to polymerization all solutions can be de-oxygenated with dry nitrogen and a slight overpressure of nitrogen can be maintained during synthesis. The working electrodes used for synthesis can be microporous and nanoporous alumina membranes of different pore size and further modified by coating with a thin film of gold. Vertically aligned polythiophene nanofibers of controllable morphology, as shown in FIGS. 6A-6C, can be grown potentiostatically at varying potential, e.g. 1.3-1.8 V (vs. Ag/AgCl). FIG. 7 illustrates effects of varying potential to produce nanotubes and nanowires, in accordance with exemplary embodiments of the present invention. The aligned nanofibers can be obtained by dissolving the alumina template with 1M KOH for a period of time, e.g. 24-48 hours.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A thermal interface material for providing thermal communication between a heat sink and a heat source, the thermal interface material comprising:
a plurality of polymer nanofibers having first ends and second ends, the first ends positioned substantially adjacent to the heat source and the second ends positioned substantially adjacent to the heat sink, wherein the plurality of polymer nanofibers are aligned substantially perpendicular to at least a portion of the heat source and the heat sink.

2. The thermal interface material of claim 1, wherein at least a portion of the polymer nanofibers comprise conjugated polymer chains.

3. The thermal interface material of claim 1, wherein at least a portion of the polymer nanofibers comprise pi-conjugated polymer chains.

4. The thermal interface material of claim 1, wherein at least a portion of the plurality of polymer nanofibers is electrically conductive.

5. The thermal interface material of claim 1, wherein the electrical conductivity of the at least a portion of the plurality of polymer nanofibers corresponds to a predetermined level of ionic doping.

6. The thermal interface material of claim 1, where a thermal conductivity of at least a portion of the plurality of polymer nanofibers corresponds to a predetermined level of ionic doping.

7. The thermal interface material of claim 1, wherein at least a portion of the polymer nanofibers comprise a semiconductor material.

8. The thermal interface material of claim 1, wherein at least a portion of the polymer nanofibers comprise a thermoelectric material.

9. The thermal interface material of claim 1, wherein at least a portion of the polymer nanofibers are electrically insulative.

10. The thermal interface material of claim 1, wherein at least a portion of the plurality of polymer nanofibers comprise a solution-processable polymer.

11. The thermal interface material of claim 1, wherein the polymer nanofibers have a length and a diameter, and wherein the length is greater than the diameter.

12. The thermal interface material of claim 1, wherein the plurality of polymer nanofibers comprise polythiophene.

13. The thermal interface material of claim 1, wherein at least a portion of the plurality of polymer nanofibers are polymer nanotubes.

14. The thermal interface material of claim 1, wherein at least a portion of the plurality of polymer nanofibers are polymer nanowires.

15. The thermal interface material of claim 1 further comprising a plurality of fillers having conductivity greater than the conductivity of the polymer nanofibers.

16. The thermal interface material of claim 15, wherein at least a portion of the fillers comprise carbon nanotubes aligned substantially perpendicular to at least a portion of the heat sink and heat source.

17. The thermal interface material of claim 15, wherein at least a portion of the fillers comprise graphene flakes.

18. The thermal interface material of claim 17, wherein at least a portion of the graphene flakes are aligned substantially perpendicular to at least a portion of the heat sink and heat source.

19. A heat transfer system comprising:
a heat source;
a heat sink; and
a thermal interface material,
wherein at least a portion of the thermal interface material is positioned substantially between the heat source and the heat sink and provides thermal communication between the heat source and heat sink, and
wherein the thermal interface material comprises a plurality of polymer nanofibers vertically aligned between at least a portion of the heat sink and at least a portion of the heat source.

20. The heat transfer system of claim 19, wherein at least a portion of the polymer nanofibers comprise conjugated polymer chains.

21. The heat transfer system of claim 19, wherein at least a portion of the plurality of polymer nanofibers comprise a solution-processable polymer.

22. The heat transfer system of claim 19, wherein at least a portion of the plurality of polymer nanofibers comprise at least one of polymer nanotubes and polymer nanowires.

23. The heat transfer system of claim 19 further comprising a plurality of fillers having a conductivity greater than the conductivity of the polymer nanofibers.

24. The heat transfer system of claim 23, wherein at least a portion of the fillers comprise carbon nanotubes aligned substantially perpendicular to at least a portion of the heat sink and heat source.

25. The heat transfer system of claim 19, wherein the thermal interface material has a thermal resistance less than 10 mm²K/W.
